(19) United States
(12) Patent Application Publication
(10) Pub. No.: US 2015/0088923 A1
(43) Pub. Date: Mar. 26, 2015

(54) USING SENSOR INPUTS FROM A COMPUTING DEVICE TO DETERMINE SEARCH QUERY

(71) Applicant: Google Inc., Mountain View, CA (US)

(72) Inventors: Laura Garcia-Barrio, Brooklyn, NY (US); David Petrou, Brooklyn, NY (US); Hartwig Adam, Marina del Rey, CA (US)

(73) Assignee: Google Inc., Mountain View, CA (US)

(21) Appl. No.: 14/033,794

(22) Filed: Sep. 23, 2013

(51) Int. Cl. G06F 17/30

(52) U.S. Cl. CPC G06F 17/30244
USPC 707/769

(57) ABSTRACT

An image input is obtained from a computing device when an image sensor of the computing device is directed to a scene. At least an object of interest in the scene is determined, and a label is determined for the object of interest. A search input is received from the computing device, where the search input is obtained from a mechanism other than the image sensor. An ambiguity is determined from the search input. A search query is determined that augments or replaces the ambiguity based at least in part on the label. A search result is based on the search query.

### BACKGROUND

Mobile computing devices can utilize resources that provide context and information. For example, such devices typically include one or more cameras, microphones and network connectivity. Such devices often use web-based search engines in order to obtain various kinds of information.

### SUMMARY

An image input is obtained from a computing device when an image sensor of the computing device is directed to a scene. At least an object of interest in the scene is determined, and a label is determined for the object of interest. A search input is received from the computing device, where the search input is obtained from a mechanism other than the image sensor. An ambiguity is determined from the search input. A search query is determined that augments or replaces the ambiguity based at least in part on the label. A search result is based on the search query.

In an aspect, the object of interest in the scene is determined by performing image analysis on the image input.

In another aspect, the label for the object of interest is determined using recognition information. The recognition information is determined from performing the image analysis, to classify or identify the object of interest.

According to another aspect, the label for the object of interest is determined by determining a feature vector for the object of interest. The feature vector is used to identify a set of similar objects. A label for the object of interest is determined based on the identified set of similar objects.

In another aspect, receiving the search input includes receiving an audio input from the computing device, and recognizing the audio input as a text string.

According to another aspect, receiving the search input includes receiving a search phrase. The ambiguity is identified by identifying a pronoun in the search phrase.

Still further, in another aspect, receiving the search phrase includes receiving a voice input corresponding to a spoken question or phrase. The ambiguity is identified by identifying a pronoun in the spoken question or phrase.

In another aspect, the object of interest in the scene can be determined by performing image analysis on the image input to determine multiple objects. An input from a second sensor other than the image sensor can be obtained. The object of interest is selected based at least in part on the input from the second sensor.

### BRIEF DESCRIPTION OF THE DRAWINGS

FIG. 1 illustrates an example search engine for processing search input from a computing device.

FIG. 2 illustrates an example search user interface, according to one aspect.

FIG. 3A illustrates an example method for processing a search input from a computing device.

FIG. 3B illustrates another example method for processing search input from a computing device.

FIG. 4 illustrates an example method for using audio and image input to obtain a search result.

FIG. 5 illustrates a method for determining a search query from a determined object of interest depicted in an image input.

FIG. 6 is a block diagram that illustrates a computer system upon which aspects described herein may be implemented.

### DETAILED DESCRIPTION

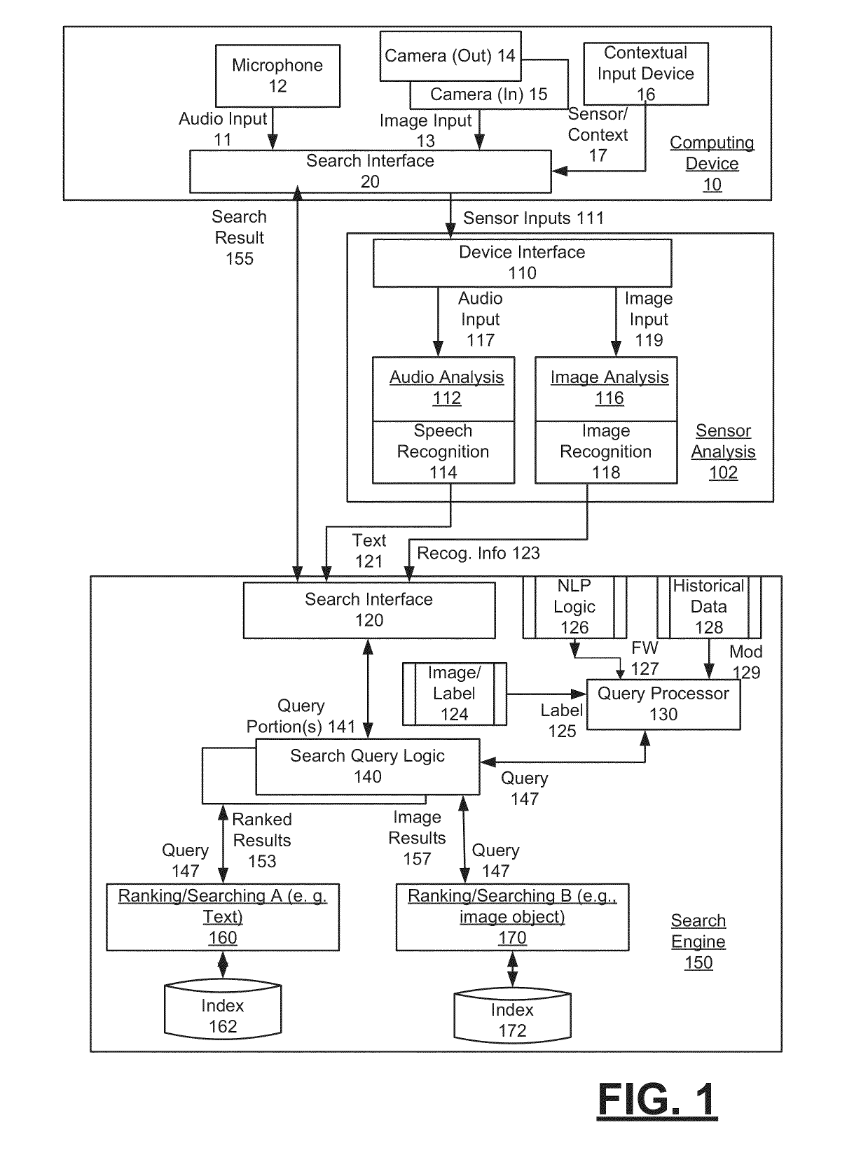

FIG. 1 illustrates an example search engine for processing search input from a computing device. In particular, a search engine 150 processes search input that includes contextual information determined at least in part from sensor inputs of a mobile computing device 10. In an aspect, the mobile computing device 10 corresponds to, for example, a smart phone, tablet, or laptop. In another aspect, the mobile computing device 10 corresponds to a wearable computing device, such as one that is integrated with a set of eyeglasses or watch. The search engine 150 can process search inputs using contextual information that is determined in part from the sensor inputs that are received on the mobile computing device 10.

In an example, the search engine 150 includes a search interface 120, a query processor 130, a search query logic 140 and one or more ranking/searching subsystems 160, 170. The mobile computing device 10 can obtain sensor inputs from various kinds of sensors, including image sensors, microphones, and/or accelerometers. In one example, the mobile computing device 10 includes a microphone 12, an outwardly directed camera (“outward camera 14”), an inwardly directed camera (“inward camera 15”) which captures an image of the user when operating the device, one or more additional input devices 16 (e.g., keypad, accelerometer, touch-screen, light sensor, or Global Positioning System (GPS)) and a search interface 20. The search interface 20 can receive audio input 11 from the microphone 12, image input 13 from each of the outward and inward cameras 14, 15, and other input 17 from the input device 16.

A sensor analysis sub-system 102 can process the sensor inputs obtained on the mobile computing device 10. The sensor analysis sub-system 102 can be provided with the search engine 150, the mobile computing device 10, or distributed between the search engine 150 and the mobile computing device 10. As a variation, the sensor analysis subsystem 102 can be provided as a separate service or component to the mobile computing device 10 and the search engines 150.

In one implementation, sensor analysis subsystem 102 includes a device interface 110 which receives sensor inputs 111 from the mobile computing device 10. The sensor inputs 111 can include the audio input 11, the image input 13, and/or the other input 17. The device interface 110 can process the sensor inputs 111, including an audio signal 117 and an image portion 119. The sensor analysis subsystem 102 can include an audio analysis component 112 to process the audio signal 117, and/or an image analysis component 116 to process the image portion 119. The audio analysis component 112 can process, for example, voice input as the audio signal 117. In one implementation, the audio analysis component 1112 includes a speech recognition component 114 that translates the audio signal 117 (e.g., voice signal) into a text string 121. The text string 121 can include, for example, terms, or phrases.

The image portion 119 can correspond to image or video (e.g., set of image frames). The image analysis component 116 can process image portion 119 by performing image recognition 118 and generating recognition information 123 corresponding to the image portion 119 of the sensor inputs. In some implementations, the image input includes a set of multiple images that are transmitted over a given duration, and the image analysis component 116 performs image recognition on multiple images in the set. In one implementation, the recognition information 123 is quantitative, such as a feature vector or signature that represents an aspect or object of the input image 119. The feature vector or signature can be used to quantitatively characterize different aspects of, for example, an object in the image portion 119, such as, for example, shape, aspect ratio, color, texture, and pattern. In this way, the feature vector or signature can utilize, for example, distance measurements as between the image portion 119 and images of the index 172, in order to determine, for example, overall visual similarity, object category, and/or cross-category similarities. As still another alternative or addition, the image analysis component 116 performs classification processes to identify an object or set of objects depicted in the image portion 119.

The search interface 120 of the search engine 150 can receive the text string 121 and/or the recognition information 123. For a given device and at a given instance, the search interface 120 associates the text string 121 with the recognition information 123. As an addition or alternative, the search interface 120 can receive other inputs 17 from the mobile computing device 10. The other inputs 17 can also be associated with the query that incorporates the text string 121 and/or the recognition information 123. By way of example, the other inputs 17 can include text input from the user (e.g., keypad entry), GPS information, and/or information from sensors such as accelerometers, optical sensors, etc. In some implementations, each of the inputs 111 can be associated with a time stamp indicating when the input was obtained on the computing device and/or transmitted to the search engine 150. The inputs 111 can be associated with one another based on the timing of the inputs 111 relative to one another. For example, the search interface 120 can associate inputs received from the mobile computing device 10 as potentially being part of a search query if the inputs are received within a designated duration of time (e.g., within a second), or in a given sequence (e.g., voice input received first, then image input or vice-versa).

The search query logic 140 can operate in connection with the query processor 130 to determine a search query 147 based on the inputs received from the mobile computing device 10. The search interface 120 can send query portions 141 corresponding to each of the text string 121, recognition information 123 and/or other inputs 17 to the search query logic 140 as query portions 141. The query processor 130 can implement various processes or services in formulating a search query for obtaining a search result. Among other functions, the query processor 130 performs tasks that correspond to formulating a text-based search query from the query portions 141.

According to an aspect, query processor 130 can perform preparatory operations for formulating a search query from the multiple inputs received on the mobile computing device. In one implementation, the query processor 130 incorporates an image label component 124 to convert the query portion 141 corresponding to the recognition information 123 into a label 125. The image label component 124 can, for example, determine an object type or class, as well as other features from the recognition information 123. The query processor 130 can use the image label component 124 in order to determine the label 125 for the query portion 141.

The query processor 130 can also process the text string 121 with natural language processing logic 126. The natural language processing logic 126 can use rules and logic to construct a framework 127 for a search query from the query portion 141. The framework 127 provides a format and/or structure for the query. Additionally, the framework 127 can include one or more of the terms that form the search query. The framework 127 can be based on, for example, the text string 121, as refined by, for example, the natural language logic 126.

Additionally, as another example, the query processor 130 can utilize a historical data component 128 to determine modifications 129 to the framework 127 for a search query. For example, the query portion 141 corresponding to the text string 121 can be parsed and manipulated into terms and/or a framework that is based on past searches. For example, word substitutions, corrections, or re-ordering of terms can be implemented based on the historical data component 128.

The query processor 130 formulates search query 147 from the processed query portions 141, including the image label 125 and the search query framework 127. Additionally, the query processor 130 can determine a subject of the query, including whether the subject of the query is ambiguous. For example, query processor 130 can operate to identify pronouns in a question or statement. Examples of pronouns include “it,” “he,” “she,” “them,” “that,” and “this.” The query processor 130 can use language rules, such as, for example, a rule in which the identification of a pronoun after a question word (e.g., “what”) is deemed a subject that is to be replaced with, for example, a label of an object of interest. Accordingly, the query processor 130 can implement processes to identify pronouns (e.g. “it” or “that”) in the text string 121, and also to replace the identified pronoun(s) with augmented or modified terms. In particular, the augmented or modified terms can be based on the label 125, which can be determined from the query portion 141 corresponding to the image label 125. As an addition or variation, the query processor 130 identifies and replaces the pronoun when the logic (e.g., rules) determines it is appropriate replacement (e.g., when the pronoun is likely the subject of the text string 121).

In this way, the query processor 130 can provide an updated query 147 to the search query logic 140. The query 147 can include a search query framework determined from processing the text string 121 and/or one or more labels determined from recognition information 123. Additionally, the query 147 can be modified and refined with, for example, the natural language processing component 126 and the historical data component 128.

The search query logic 140 implements one or more searches using the updated query 147 in order to obtain a search result 155 for the mobile computing device 10. In one implementation, the updated query 147 is in the form of structured phrase which can be processed by the text-based search subsystem 160 and index 162. The search subsystem 160 can provide the result 153, which can include that are ranked. The items of the result 153 can include, for example, links to web pages, documents, images and/or summaries that are ranked based on a determination of relevance to the search query 147. The determination of relevance can be based in part on ranking signals and other inputs, which can weight individual items of the result 153 to be more or less relevant. As an example, the query 147 can seek answers to questions such as “What is it?” or “Where can I get that?” In response to receiving the query 147, the text-based search subsystem 160 can return a ranked set of results 153. The ranked set of results 153 can be passed to the mobile computing device 10 as a search result 155, or processed further before being returned as the search result 155.

In some examples, the search query logic 140 selects the type of search to initiate based on additional contextual information. The additional contextual information provided from the inputs of the mobile computing device 10. For example, the search query logic 140 can select to initiate image similarity operations if the updated search query 147 includes phrases such as “more like” or “look like this.” Likewise, the search query logic 140 can select to initiate navigation or mapping functionality based on the presence of terms such as “here” or “address.”

In some examples, the search query logic 140 performs mufti-pass searches. For example, a mufti-sensor input from the computing device 10 can be processed by the query processor 130 for image labels, and the updated query 147 can then be searched using the label (e.g., in place of a pronoun or ambiguity). The search component 140 can perform one or more additional searches using the result of the prior search. For example, the input can correspond to a phrase (e.g., “what desserts can I make with this?”) and an image (e.g., food item). In response, the query processor 130 can recognize the label of the food item using, for example, the image label component 124. The text-based ranking/searching sub-system 160 can be used to obtain result 153 in which a recipe is identified that incorporates the food item. A subsequent search can be used to determine a location where an item from the recipe can be purchased.

As another example, the recognition information 123 determined from the image analysis component 116 can correspond to a feature vector for the object of interest. The feature vector can be used as a search criterion against, for example, the image similarity search subsystem 170 and index 172, to identify a set of similar objects. The search query logic 140 can determine a result that includes the set of similar objects, and the query processor 130 can determine the label 125 for the object of interest based on the identified set of similar objects.

In some implementations, the search engine 150 can also process responses from computing device 10 to search result 155 as a follow on to a prior query or set of queries. For example, the user can receive a search result and then enter additional input(s) (e.g., voice input) to ask follow on questions regarding a previous query. This can, for example, permit the user to carry on a “conversation” in which the user interacts with the computing device 10 to ask a question related to a prior search result. The user's interaction with the computing device 10 can then be in the form of a series of related questions and answers. According to one aspect, the search query logic 140 can process follow on inputs as relating to the prior query or search result in response to conditions or events that indicate the queries are to be related. For example, a subsequent set of inputs 111 can be interpreted as a follow on to a preceding query if the subsequent inputs 111 are received within a given duration of time following preceding inputs 111 of a processed query. The subsequent inputs 111 can include inputs from any of the devices of the computing device 10, including the microphone 12, cameras 14, 15 and/or input device 16. The sensor analysis sub-system 102 can process the sensor inputs 111 as, for example, text string 121 and/or recognition information 123.

In some implementations, if criteria is met to associate query portions 141 from the subsequent inputs 111 to a preceding query (e.g., subsequent inputs 111 obtained within a designated duration from a preceding set of inputs), the search query logic may process the query portion 141 determined from the subsequent inputs 111 using determinations of the prior query or search result as context. For example, if the subsequent input 111 includes a voice input that contains an ambiguity (e.g., pronoun), then the ambiguity may be resolved using the label 125 determined from the prior set of inputs 111. As an alternative or variation, the query 147 determined from the follow on set of inputs 111 can be refined or provided contextual information that is based on the prior query and/or search result. As still another example, the search result 155 returned from the recent query can be refined based on a prior query or search result.

As another variation, multiple queries 147 can be deemed to be related to one another even if the queries are determined from multiple inputs 111 that originate from different sensor components or input devices of the computing device 10. For example, a first query 147 can be determined from inputs that utilize the camera 15 and a Global Positioning System (GPS), and a second related query 147 can be determined from microphone 12 and/or the camera 15.

Still further, the computing device 10 and/or search engine 150 can be configured to accept a first set of inputs (e.g., image, or image and voice) and to return a response that displays options to the user for providing additional inputs. The user can then elect to provide inputs for a follow on query using, for example, selection input made through a touch-screen. By way of example, the user can specify an image and voice input for a query, and then be prompted with a screen that enables the user to elect to provide additional voice input and/or image input for a follow on query.

### Examples

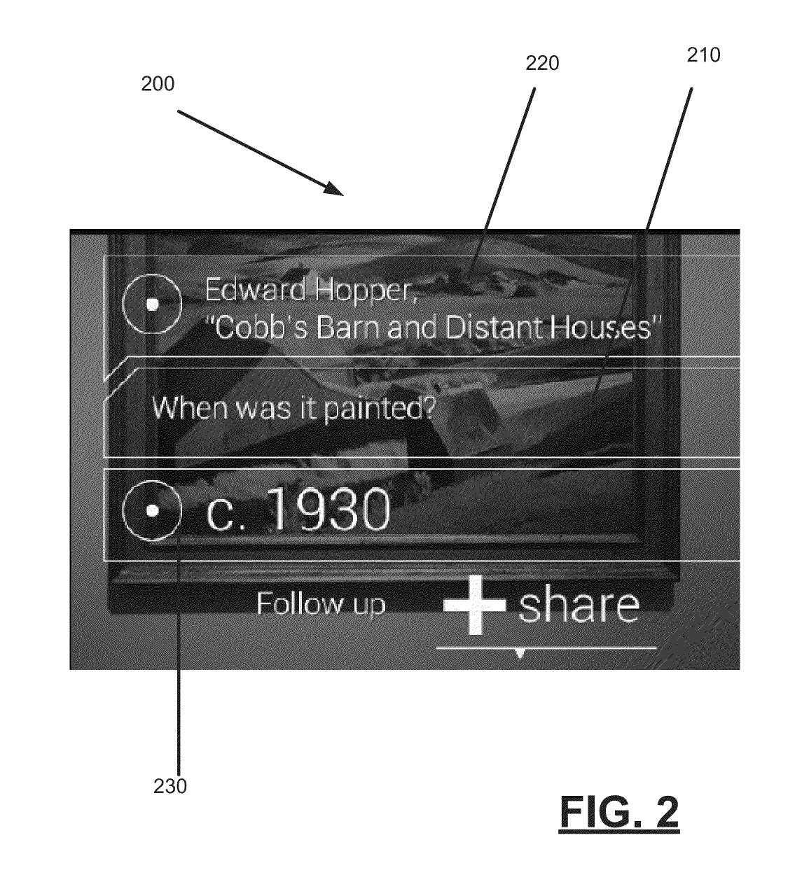

FIG. 2 illustrates an example search user interface, according to one aspect. The example search user interface can be provided as part of search engine 150 (see FIG. 1). For example, search user interface of FIG. 2 can be provided by the search engine 150, for display on the computing device 10. In an example of FIG. 2, the computing device 10 corresponds to computerized eyewear that renders an interface 200 as an overlay over a scene viewable through the lens of the device. Further in the example provided, a user may be able to provide input by providing a voice query, and also by viewing a scene and directly or indirectly causing a camera of the device to capture the scene. In variations, the interface 200 may correspond to a display screen of the computing device, such as a smart phone or tablet. The interface 200 can be implemented with device processes that integrate sensor input (e.g., microphone, outward camera etc.) into visual feedback or content provided on the interface 200. For example, a phrase spoken by the user can be detected by microphone and the resulting speech recognition can be displayed to the user on the screen.

In an example of FIG. 2, the interface 200 depicts a search input 210 provided by voice input from a user. In one implementation, the search input 210 is specified by the user (e.g., phrase spoken), and then the image input is processed in connection with the spoken phrase. In a variation, the scene is captured using a series of images (e.g., video), and the user's enunciation follows the scene capture and image analysis. The search input 210 includes an ambiguity, in the form of a pronoun: “When was it painted?” The camera of the device further captures image input of the scene, corresponding to a painting.

The search engine 150, for example, can perform operations that include resolving the ambiguity of the search input 210. In the example provided, the ambiguity corresponds to the enunciation of the pronoun. The image input 13 can correspond to the scene, which in the example provided, depicts the painting. The image analysis component 116, in combination with the query processor 130 (and the image label component 124), determine a label (e.g., “Edward Hopper, ‘Cobb's Barn and Distant House’”) for the painting. The search engine 150 can operate to generate a search query that replaces the ambiguity with the determined label 220. A search result 230 can be obtained in response to the search query in which the label 220 is specified.

As other examples, a user may interact with interface 200 to perform product searches based on image data captured on the computing device 10. For example, the user can direct an outward camera to a product and enunciate a search phrase which does not specifically identify the product (e.g., “where can I buy that cheaper?” or “show me more shoes like these.”). The computing device 10 can process the voice input for audio recognition (or alternatively send the voice input to another component or service for such recognition). Likewise, the computing device 10 sends the image input to, for example, the image analysis component 116 in order to determine recognition information 123 about the object of interest (e.g., a product). The search engine 150 can formulate a framework for the search query from the voice input. The search engine 150 can also identify the pronoun (“it”) corresponding to the subject of the query. The image label component 124 can determine a label for the product based on the recognition information 123. The search engine 150 can replace the pronoun in the search framework 127 with the determined label 125, then initiate a search from the resulting query 147 using a product database that ranks search results based on price.

As another example, the voice input can correspond to “show me more shoes like these,” and the image input (e.g., from an outward facing camera 14) can capture an image of a shoe. The search query logic 140 can use the recognition information 123 to initiate an image similarity search from the image sub-search system 170 and index 172. The image search result 157 may include image content items (e.g., web pages or documents containing images that match the search result) that are deemed to match the search query 147. In the example in which the search query is for “show me more shoes like these,” the image search result 157 can include image content items that include similar shoes from, for example, retailers. The image content items of the image search result 157 can also be ranked, based on signals such as a determination of similarity between the recognition information 123 and the image content items of the result 157.

As another example, the search engine 150 can provide search results pertaining to persons that are captured by the image sensors of the computing device 10. The recognition information 123 determined from the image portion 119 can be used to determine, for example, social networking posts of the particular user or contact information a user may have about the particular individual.

As another example, the image input can be directed to media that depicts a point of interest or landmark. A phrase such as “How do I get here?” may be received in connection with an image input. The recognition information 123 can be referenced against image labeling component 124 to yield a label that identifies the point of interest or landmark. The search query logic 140 uses the search label 125 to supplement the phrase (e.g., replace the pronoun) in formulating the query 147. A search can be initiated based on the query 147 using, for example, a navigation search sub-system (e.g., directions to a location).

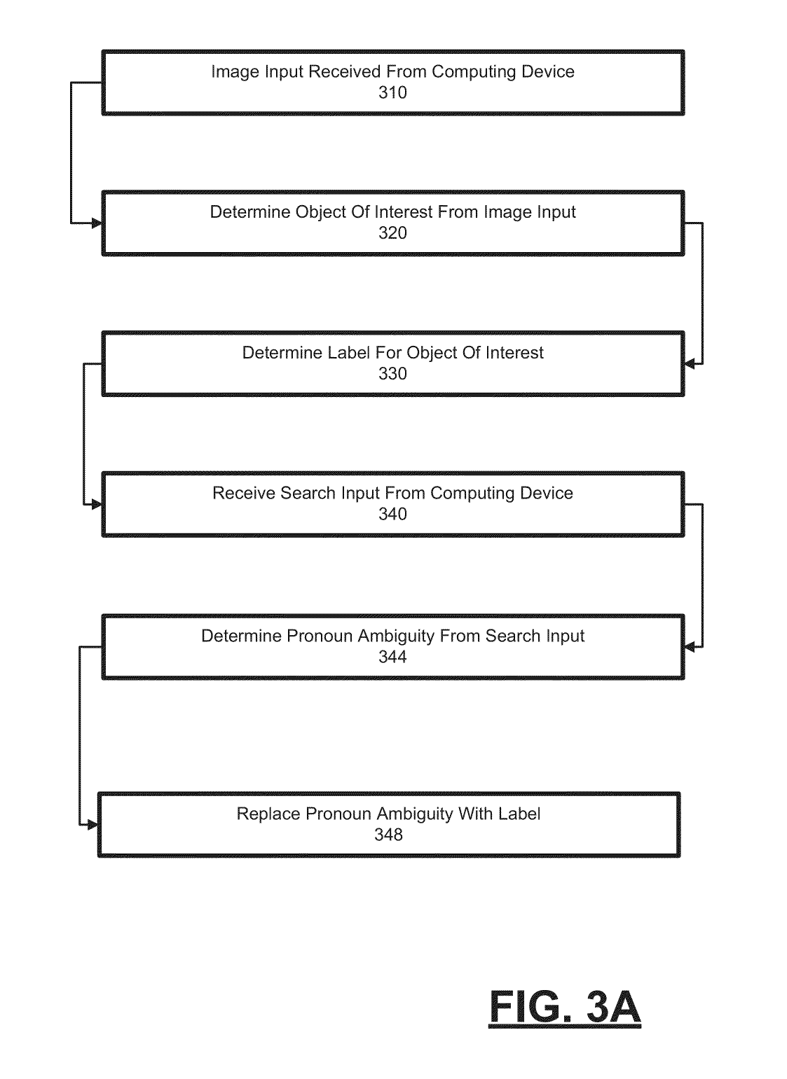

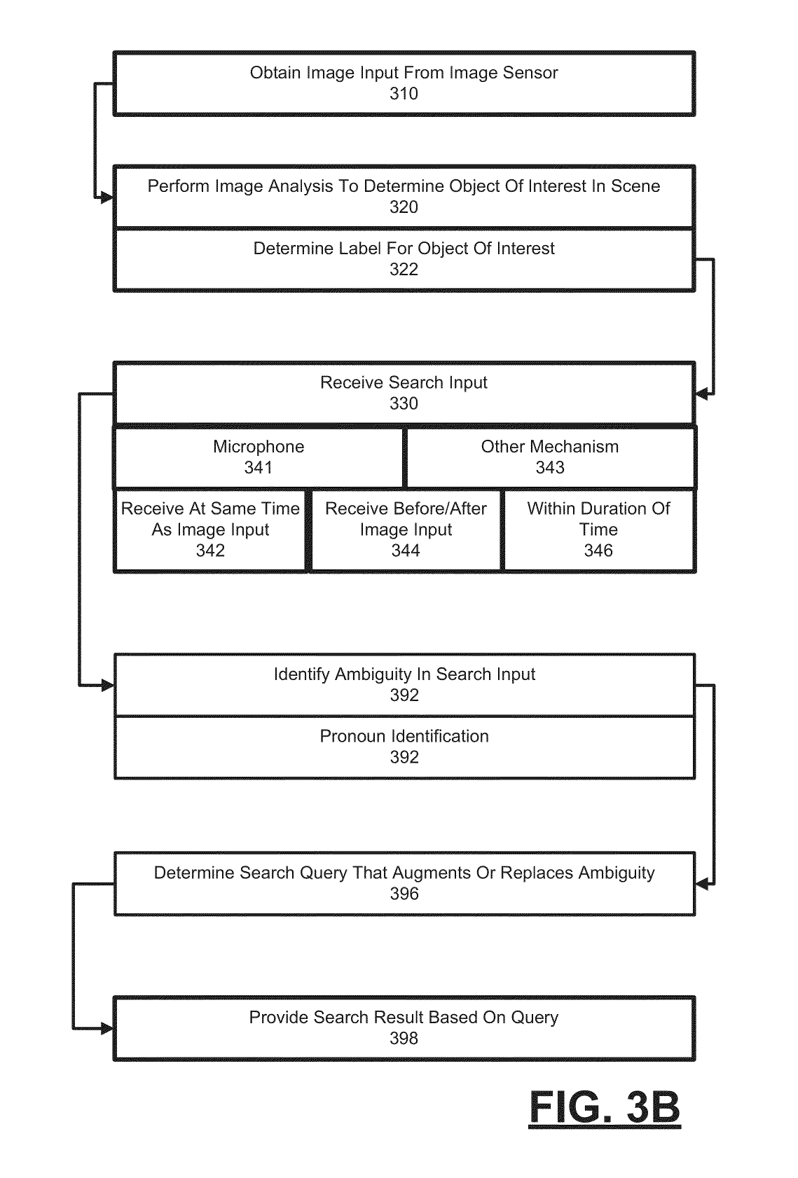

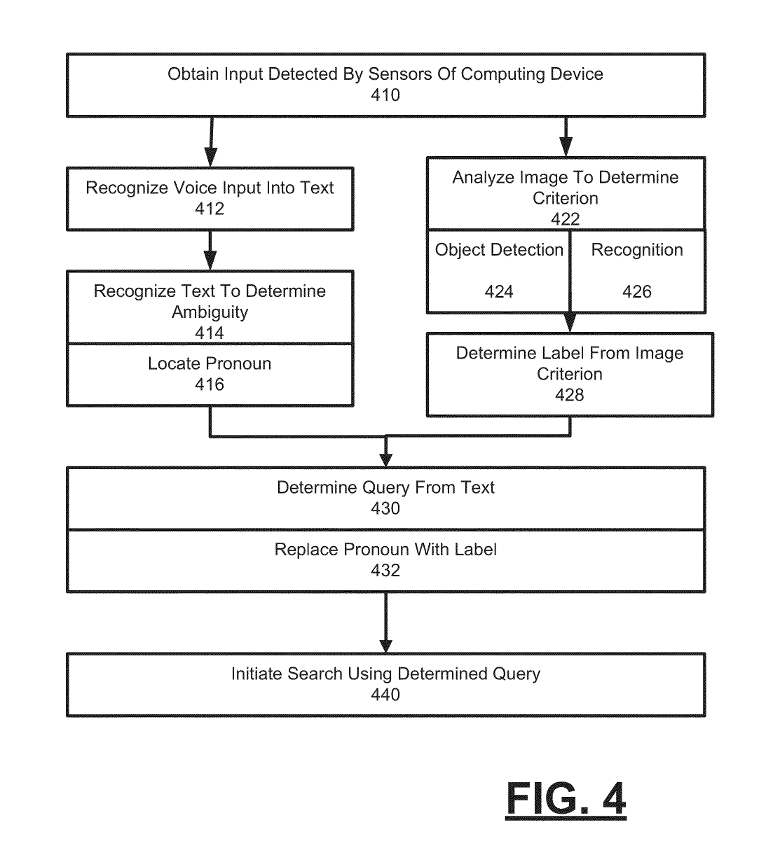

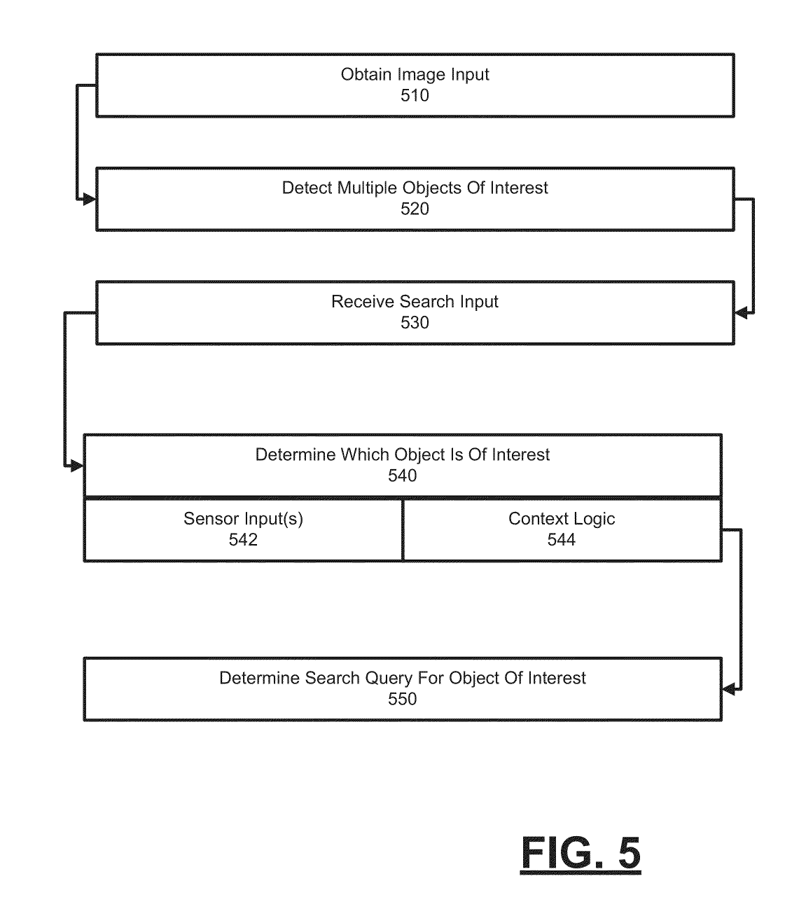

FIG. 3A illustrates an example method for processing a search input from a computing device. FIG. 3B illustrates another example method for processing search input from a computing device. FIG. 4 illustrates an example method for using audio and image input to obtain a search result. FIG. 5 illustrates a method for determining a search query from a determined object of interest depicted in an image input. Example methods such as described with FIG. 3A, FIG. 3B, FIG. 4 and FIG. 5 may be implemented using, for example, a system such as described with FIG. 1. Accordingly, reference may be made to elements of FIG. 1 in describing a step or sub-step described with examples of FIG. 3B, FIG. 4 and FIG. 5.

With reference to FIG. 3A, image input can be received from a computing device (310). The image input can reflect a scene that is captured by the image sensor. The image input can, for example, be communicated from a computing device to a server or network service such as described with an example of FIG. 1.

An object of interest can be determined from the image input (320). For example, the object of interest can be the object that is prominent and/or centered in the image input. Alternatively, as described with other examples, the object of interest can be selected from other objects using contextual determinations, which can be determined other sensor inputs or signals.

A label is determined from the object of interest (330). The label can correspond to, for example, a term or series of terms that are descriptive of the object of interest. By way of example, the label can correspond to a category designation or recognized information about the object of interest.

A search input is received from the computing device (340). The search input can be provided from a mechanism other than the image sensor of the computing device. For example, the mechanism can correspond to a microphone or input mechanism. Depending on the implementation, the search input can be received before, after or at the same time as the image input.

An ambiguity is determined from the search input. For example, a pronoun may be provided in the search input (344). The ambiguity can be replaced or augmented with the identified label (348). A search query can then be formulated based on the label and the search input (350).

With reference to FIG. 3B, image input is obtained from an image sensor of the computing device (360). According to an aspect, the image input reflects a scene that is being viewed through the computing device in real-time. For example, a computerized set of eyeglasses may capture image or video data, which is then communicated to search engine 150. As another example, image or video data may be captured on mobile computing device 10, which can correspond to, for example, a smart phone or tablet.

Image analysis may be performed to determine an object of interest depicted in the image input (370). The image analysis may correspond to, for example, object detection and/or image recognition. In one example, facial recognition can also be performed. In one implementation, recognition information 123 is used to determine information about the object of interest, such as a classification or type of the object, or more specific information, such as an identification of the object (372).

In addition to the image input, a search input is received from the mobile computing device 10 (380). The search input may be provided from a contextual input mechanism other than the image sensor. For example, the search input may be entered as a voice signal received on the microphone of the mobile computing device 10 (381). Alternatively, an input mechanism such as a touch screen or keypad may provide input corresponding to the search input (383).

In some implementations, an event, such as user input, triggers the capture of inputs from the image sensor and other mechanism of the mobile computing device 10. The inputs can be communicated to the search engine 150 for determination of a search query. According to one aspect, the timing of the sensor inputs (e.g., voice and image) determines whether the inputs are processed as part of same search query. For example, the sensor inputs can be associated with a time stamp that indicates an approximate time when that input was received on the computing device 10 or transmitted to the search engine 150. In one variation, the search input (e.g., as interpreted through a voice input) and the image input are processed as a search query when computing device 10 obtains the inputs at substantially a same time (382). For example, the image input may be acquired on the computing device over a duration when the user is asking a question and providing the voice input, so that the time when the image and voice inputs are individually acquired overlap with one another.

In a variation, the search input (e.g., as interpreted through a voice input) and image input can be processed as a search query when received in a given sequence (384). In one implementation, the search input (e.g., voice input) precedes the image input, and the search input and the image input are communicated in response to, for example, the user asking a question or performing some other contextual action. The search input and the image input can be correlated to one another by, for example, search engine 150. In a variation, the image input may precede the search input (e.g., voice input). Still further, as an addition or alternative, the search input and the image input may be correlated to one another if the two inputs are received within a given duration of time (386). For example, a voice input and an image input may be correlated to one another if they are received within a designated number of seconds of one another (e.g., ten seconds).

In one implementation, the search input is processed to determine an ambiguity in the wording of the input (390). The ambiguity can correspond to identification of the pronoun, or a pronoun that is present is the subject of the sentence or phrase (392).

A search query is determined that augments or replaces the ambiguity using the determined label determined for the object of interest (396). For example, a pronoun can be identified from the search input, which can be based on a voice input or a text input. In one implementation, the pronoun is replaced with the label 125 determined from the image input. In a variation, the label 125 is used to determine additional terms that can replace or augment the label. For example, a user may take a picture of an item of clothing, then provide input (e.g., microphone input) asking, “How much does it cost?” An initial image recognition or object classification may determine the label to correspond to the item of clothing by type. A search may be performed to return additional facets, such as a specific brand or a trend that is most relevant to the type of clothing. The additional terms, such as a brand or trend, may be used in place of an ambiguous term in formulating the search query 147.

The search query can be used to determine one or more search results 155 for the computing device (398). For example, the search query logic 140 can use one or more search sub-systems 160, 170 to determine a ranked set of results for the search query 147.

With reference to an example of FIG. 4, inputs are obtained from multiple sensors of a computing device (410). For example, the computing device 10 can obtain inputs from a microphone and an image sensor, and then communicate the inputs to a search engine. The inputs can be received at approximately the same time, or at different times (e.g., within a designated number of seconds from one another). Each of the inputs can be processed. For example, the audio signal can be recognized into text (412). The text can be analyzed to determine an ambiguous term (414), such as a pronoun or other vague term that appears as a subject of a spoken phrase or sentence (416).

The image input can be analyzed to determine additional search criterion (422). For example, the image input can be recognized for object detection (424) and/or recognition information (426). The search criterion determined from the image analysis can be used to determine a label (428).

According to one aspect, a query can be determined from the text that corresponds to the voice input (430). An ambiguity (e.g., pronoun) can be determined from the pronoun included in the recognized text. The pronoun may be replaced with the label as determined from the image analysis (432). A search can then be initiated using the determined query (440).

With reference to FIG. 5, an image input is obtained (510) from a computing device. The image input can be processed to detect multiple objects of interest (520). For example, the image analysis component 116 can process the image input 13 from the mobile computing device 10 in order to detect multiple objects in one scene.

In addition to receiving the image input, search input can be received (530). For example, the user may provide voice input corresponding to a phrase.

The search engine 150 can implement logic in order to determine which object the search input is to relate to (540). In one example, the mobile computing device 10, the sensor analysis 102 and/or the search engine 150 (e.g., search query logic 140) processes additional sensor input in order to determine information clues as to the object of interest (542). In one implementation, for example, input from the inward camera 15 can implement gaze tracking in order to identify a location where the user is looking. The direction of the gaze of the user can be mapped to one of the multiple detected objects in the image input 13.

As an addition or alternative, context logic 544 can be used to determine which of the multiple objects detected from the image input 13 is of interest. The context logic 544 can, for example, apply clues in the wording the of the search input and/or other sensor input in order to determine which of the multiple objects is likely of interest. For example, the context logic 544 can use audio input and/or image input to determine that the image input is from an urban setting. Then the context logic 544 can apply the phrase “how tall is that?” to the largest object (e.g., tallest building) depicted in the scene.

A search query can then be determined for the object of interest (550). For example, the search query can be applied to the determined object of interest, rather than to another possible candidate. As till another example such as described with an example of FIG. 3B, a label can be determined for the object of interest, and an ambiguity in the search query can be replaced or augmented with the label of the determined object of interest.

Computer System

Examples described herein provide that methods, techniques and actions performed by a computing device are performed programmatically, or as a computer-implemented method. Programmatically means through the use of code, or computer-executable instructions. A programmatically performed step may or may not be automatic.

Examples described herein may be implemented using programmatic modules or components. A programmatic module or component may include a program, a subroutine, a portion of a program, or a software component or a hardware component capable of performing stated tasks or functions. As used herein, a module or component can exist on a hardware component independently of other modules or components. Alternatively, a module or component can be a shared element or process of other modules, programs or machines.

Furthermore, examples described herein may be implemented through the use of instructions that are executable by one or more processors. These instructions may be carried on a computer-readable medium. Machines shown or described with figures below provide examples of processing resources and computer-readable mediums on which instructions for implementing examples described herein can be carried and/or executed. In particular, the numerous machines shown with examples include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash or solid state memory (such as carried on many cell phones and consumer electronic devices) and magnetic memory. Computers, terminals, network enabled devices (e.g., mobile devices such as cell phones) are all examples of machines and devices that utilize processors, memory, and instructions stored on computer-readable mediums. Additionally, examples may be implemented in the form of computer-programs, or a computer usable carrier medium capable of carrying such a program.

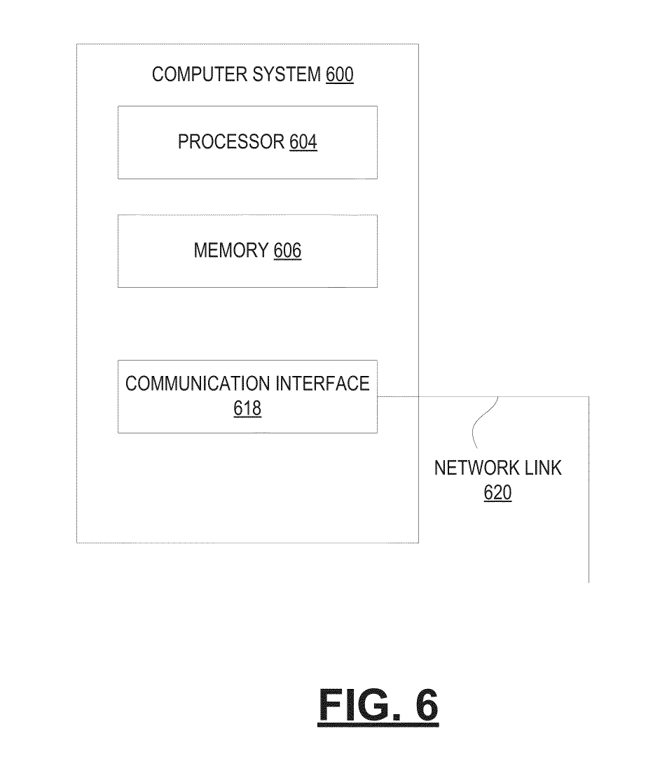

FIG. 6 is a block diagram that illustrates a computer system upon which aspects described herein may be implemented. For example, in the context of FIG. 1, search engine 150 can be implemented in part using a computer system such as described by FIG. 6.

In one implementation, computer system 600 includes processor 604, memory 606 (including non-transitory memory), and communication interface 618. Computer system 600 includes at least one processor 604 for processing information. Computer system 600 also includes a memory 606, such as a random access memory (RAM) or dynamic storage device, for storing information and instructions to be executed by processor 604. The memory 606 also may be used for storing temporary variables or other intermediate information during execution of instructions to be executed by processor 604. Computer system 600 may also include a read only memory (ROM) or other static storage device for storing static information and instructions for processor 604. The communication interface 618 may enable the computer system 600 to communicate with a network, or a combination of networks, through use of the network link 620 (wireless or wireline).

Examples described herein are related to the use of computer system 600 for implementing the techniques described herein. According to one aspect, those techniques are performed by computer system 600 in response to processor 604 executing one or more sequences of instructions contained in memory 606. Such instructions may be read into memory 606 from another machine-readable medium, such as storage device 610. Execution of the sequences of instructions contained in memory 606 causes processor 604 to perform the process steps described herein. In alternative implementations, hard-wired circuitry may be used in place of or in combination with software instructions to implement examples such as described herein. Thus, examples as described are not limited to any specific combination of hardware circuitry and software.

Although illustrative examples have been described in detail herein with reference to the accompanying drawings, variations to specific aspects and details are encompassed by this disclosure. It is intended that the scope described herein can be defined by claims and their equivalents. Furthermore, it is contemplated that a particular feature described, either individually or as part of an example, can be combined with other individually described features, or parts of other examples. Thus, absence of describing combinations should not preclude the rights to such combinations.

What is claimed is:

1. A method, the method being implemented by one or more processors and comprising:
receiving an image input from a computing device, wherein the image input is obtained from an image sensor of the computing device when the image sensor of the computing device is directed to a scene;
determining at least an object of interest in the scene;
determining a label for the object of interest;
receiving a search input from the computing device, wherein the search input is obtained from a mechanism other than the image sensor;
identifying an ambiguity in the search input;
determining a search query that augments or replaces the ambiguity based at least in part on the label; and
providing a search result based on the search query.

2. The method of claim 1, wherein determining at least the object of interest in the scene includes performing image analysis on the image input.

3. The method of claim 2, wherein determining the label for the object of interest includes using recognition information, determined from performing the image analysis, to classify or identify the object of interest.

4. The method of claim 3, wherein determining the label for the object of interest includes determining a feature vector for the object of interest, using the feature vector to identify a set of similar objects, and determining a label for the object of interest based on the identified set of similar objects.

5. The method of claim 1, wherein receiving the search input includes receiving an audio input from the computing device, and recognizing the audio input as a text string.

6. The method of claim 1, wherein receiving the search input includes receiving a search phrase, and wherein identifying the ambiguity includes identifying a pronoun in the search phrase.

7. The method of claim 6, wherein receiving the search phrase includes receiving a voice input corresponding to a spoken question or phrase, and wherein identifying the ambiguity includes identifying a pronoun in the spoken question or phrase.

8. The method of claim 1, wherein determining at least the object of interest in the scene includes:
performing image analysis on the image input to determine multiple objects,
receiving an input from a context mechanism other than the image sensor, and
selecting the object of interest from the multiple objects based at least in part on the input from the context mechanism.

9. The method of claim 8, wherein the context mechanism corresponds to a second image sensor that is directed inwards towards a user.

10. The method of claim 8, wherein the context mechanism corresponds to a microphone.

11. The method of claim 1, wherein receiving the image input and determining at least the object of interest is performed before receiving the search input from the computing device.

12. The method of claim 1, wherein receiving the image input and determining at least the object of interest is performed after receiving the search input from the computing device.

13. The method of claim 1, wherein receiving the image input includes receiving a series of image frames over a duration of time, and wherein determining at least the object of interest is performed repeatedly for the series of image frames and independently of receiving the search input.

14. The method of claim 13, wherein the context mechanism includes one or more of an accelerometer, ambient light sensor, or global positioning system (GPS) component.

15. A computer system comprising:
one or more processors;
a memory that stores instructions;
wherein the one or more processors access instructions stored in the memory to:
receive an image input from a computing device, wherein the image input is obtained from an image sensor of the computing device when the image sensor of the computing device is directed to a scene;
determine at least an object of interest in the scene;
determine a label for the object of interest;
receive a search input from the computing device, wherein the search input is obtained from a mechanism other than the image sensor;
identify an ambiguity in the search input;
determine a search query that augments or replaces the ambiguity based at least in part on the label; and
provide a search result based on the search query.

16. The computer system of claim 15, wherein the one or more processors determine at least the object of interest in the scene by performing image analysis on the image input.

17. The computer system of claim 16, wherein the one or more processors determine the label for the object of interest by using recognition information, determined from performing the image analysis, to classify or identify the object of interest.

18. The computer system of claim 16, wherein the one or more processors determine the label for the object of interest by:
determining a feature vector for the object of interest,
using the feature vector to identify a set of similar objects, and
determining a label for the object of interest based on the identified set of similar objects.

19. The computer system of claim 15, wherein the one or more processors receive the search input by receiving an audio input from the computing device, and recognizing the audio input as a text string.

20. A computer-readable medium that stores instructions, that when executed by one or more processors, cause the one or more processors to perform operations comprising:
receiving an image input from a computing device, wherein the image input is obtained from an image sensor of the computing device when the image sensor of the computing device is directed to a scene; determining at least an object of interest in the scene;
determining a label for the object of interest;
receiving a search input from the computing device, wherein the search input is obtained from a mechanism other than the image sensor;
identifying an ambiguity in the search input;
determining a search query that augments or replaces the ambiguity based at least in part on the label; and
providing a search result based on the search query.
